(19) United States
(12) Patent Application Publication
(10) Pub. No.: US 2006/0087594 A1
(43) Pub. Date: Apr. 27, 2006

(54) Television signal transmitter

(75) Inventors: Akihide Adachi, Fukushima-ken (JP); Yasuharu Kudo, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD

(21) Appl. No.: 11/269,195

(22) Filed: Oct. 24, 2005

(30) Foreign Application Priority Data
Oct. 26, 2004 (JP) 2004-311351

(51) Int. Cl. H04N 5/455

(52) U.S. Cl. 348/726; 348/731

(57) ABSTRACT

A television signal transmitter includes a first frequency converting circuit that converts a television channel signal lower than a television broadcasting band into a first intermediate frequency signal higher than the television broadcasting band, and a second frequency converting circuit that converts the first intermediate frequency signal into the television broadcasting band and outputs it. An input amplifying circuit for amplifying the input television channel signal is provided at a previous stage of the first frequency converting circuit, and a band-pass filter is provided between the first frequency converting circuit and the second frequency converting circuit. The band of the input amplifying circuit and the band of the band-pass filter are a transmission band of a plurality of successive channels.

### BACKGROUND OF THE INVENTION

1. Field of the Invention

The present invention relates to a television signal transmitter, which is used in a transmission side such as a CATV system to transmit a television signal.

2. Description of the Related Art

FIG. 3 is a view illustrating a portion of a conventional television signal transmitter, which is mounted in every channel for sending a transmitted program. An intermediate frequency circuit 41 includes a modulator (not shown) to modulate a video intermediate frequency carrier (45.75 MHz in USA) by a video signal V of the program to be transmitted and to output a video intermediate frequency signal. In addition, an audio signal S is located in an audio intermediate frequency signal (41.25 MHz) separated from the video intermediate frequency signal by 4.5 MHz by a predetermined process so as to be carried. For convenience sake, hereinafter, the intermediate frequency signal including the video intermediate frequency signal and the audio intermediate frequency signal output from the intermediate frequency circuit 41 is referred to as a first intermediate frequency signal.

The first intermediate frequency signal output from the intermediate frequency circuit 41 is input to a first mixing circuit 42 and is mixed with an oscillating signal from a first local oscillating circuit 43 to be frequency-converted into a second intermediate frequency signal of about 1.3 GHz. Accordingly, the first mixing circuit 42 and the first local oscillating circuit 43 constitute a first frequency converting circuit 44. The second intermediate frequency signal output from the first mixing circuit 42 passes through a band-pass filter 45 having a predetermined bandwidth (approximately 6 MHz). After that, the second intermediate frequency signal is amplified to a predetermined level in a second intermediate frequency amplifying circuit 46 and is input to a second mixing circuit 47. The amplified signal is mixed with an oscillating signal output from a second local oscillating circuit 48 in the second mixing circuit 47 to be converted into a third intermediate frequency signal. Accordingly, the second mixing circuit 47 and the second local oscillating circuit 48 constitute a second frequency converting circuit 49.

Here, the frequency of the third intermediate frequency signal differs from program to program to be transmitted and an oscillating frequency of the second local oscillating circuit 48 is set to be matched to any one of channel frequencies set within the range of about 50 MHz to 1 GHz. The third intermediate frequency signal output from the second mixing circuit 47 is added with a predetermined gain in third intermediate frequency amplifying circuits 50 and 51, and then passes through a band-pass filter 52 and an output amplifying circuit 53 to be derived. Subsequently, the third intermediate frequency signal is mixed with a third intermediate frequency signal derived from another transmitting circuit in the same way at a mixing circuit (not shown) to be transmitted to a cable (not shown) (for example, see JP-A-10-304257 (FIG. 6)).

The television signal transmitter is installed in every channel to be transmitted. That is, an intermediate frequency signal of one channel is input from an intermediate frequency circuit to a mixer. Accordingly, since a plurality of television transmitters needs to be installed in a transmitting source of a CATV system in correspondence with the number of the channels to be transmitted, there has been a problem that installation costs increases.

### SUMMARY OF THE INVENTION

It is an object of the invention to provide a television signal transmitter capable of transmitting television signals of a plurality of channels at one time by use of one television signal transmitter.

According to a first aspect of the invention, a television signal transmitter includes a first frequency converting circuit that converts a television channel signal lower than a television broadcasting band into a first intermediate frequency signal higher than the television broadcasting band, and a second frequency converting circuit that converts the first intermediate frequency signal into the television broadcasting band and outputs it. In this case, a pass-band between an input port and an output port is a transmission band of a plurality of successive channels.

Furthermore, according to a second aspect of the invention, in the above-mentioned structure, it is preferable that a level changing unit be provided at a previous stage of the first frequency converting circuit, and an Automatic Gain Control (AGC) circuit that detects a level of the television channel signal input to the first frequency converting circuit to generate an AGC voltage and controls the level changing unit to make the level of the television channel signal input to the first frequency converting circuit uniform by use of the AGC voltage and an input channel number discriminating unit that detects the level of the television channel signal at the previous stage of the level changing unit to discriminate the channel number of the television channel signal input to an input amplifying circuit be provided, and the AGC voltage be converted according to the channel number.

Moreover, according to a third aspect of the invention, in the above-mentioned structure, it is preferable that, the television channel signal be provided at a frequency band higher than the band of one channel adjacent to the lower frequency of the intermediate frequency band of a television system.

### BRIEF DESCRIPTION OF THE DRAWINGS

FIG. 1 is a circuit diagram illustrating a structure of a television signal transmitter according to the invention;

FIG. 2 is a view illustrating a frequency relationship of the television signal transmitter according to the invention; and

FIG. 3 is a circuit diagram illustrating a conventional television signal transmitter.

### DESCRIPTION OF THE PREFERRED EMBODIMENT

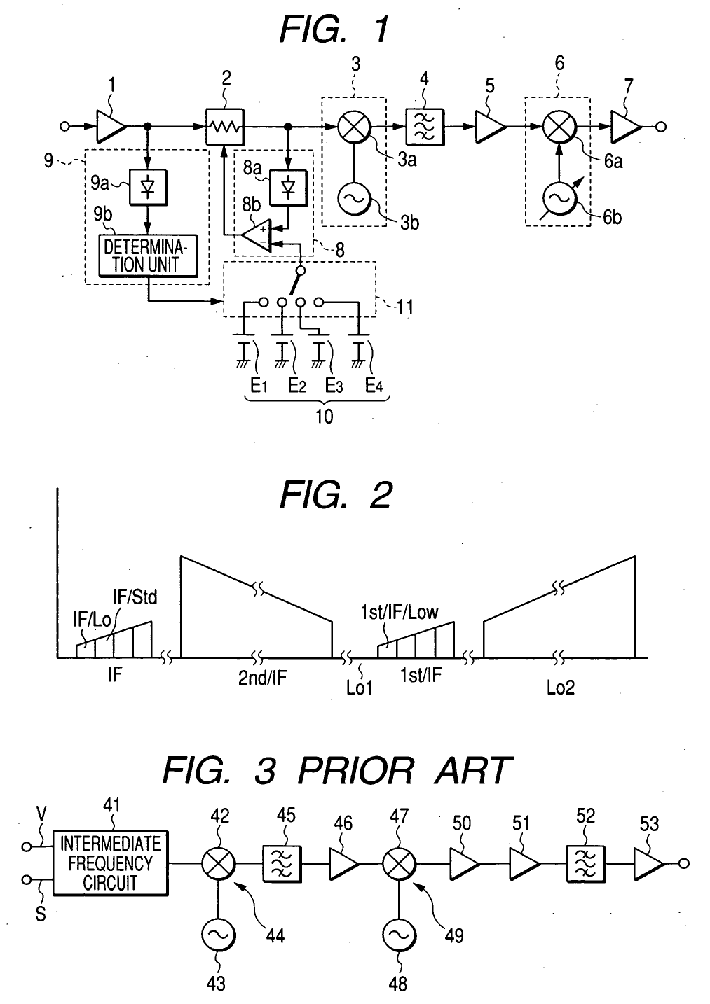

A structure of a television signal transmitter according to the invention will be described with reference to FIG. 1. As shown in FIG. 1, an input amplifying circuit 1, a level changing unit 2, a first frequency converting circuit 3, a band-pass filter 4, a first intermediate frequency amplifying circuit 5, a second frequency converting circuit 6, and an output amplifying circuit 7 are provided in this order.

Since a television channel signal having a frequency lower than a television broadcasting band, for example, a signal of an intermediate frequency band (intermediate frequency signal) of a television system and a plurality of television channel signals which are continuous and have a same bandwidth in a high frequency and a low frequency of the intermediate frequency band, is input to the input amplifying circuit 1, the input amplifying circuit 1 has a transmission band of a plurality of successive channels including the intermediate frequency band. The levels of the input television channel signals are substantially equal to one another. The television channel signal output from the input amplifying circuit 1 is controlled to a prescribed level by the level changing unit 2 and then are input to a first mixing circuit 3a of the first frequency converting circuit 3. The level changing unit 2 is composed of, for example, a variable attenuation circuit.

The television channel signal input to the first mixing circuit 3a is mixed with a first local oscillating signal output from a first local oscillating circuit 3b to be frequency-converted into a first intermediate frequency signal equal to a sum of the frequencies. Since the oscillating frequency of the first local oscillating circuit is set to be higher than that of the television broadcasting band, the frequency of the first intermediate frequency signal is higher than that of the television broadcasting band.

The first intermediate frequency signal is input to the first intermediate frequency amplifying circuit 5 through the band-pass filter 4. However, the band-pass filter 4 has a pass-band of a plurality of successive channels and the first intermediate frequency amplifying circuit 5 has transmission characteristics of the band corresponding thereto. The amplified first intermediate frequency signal is input to a second mixing circuit 6a of the second frequency converting circuit 6, and is mixed with a second local oscillating signal output from a second local oscillating circuit 6b to be frequency-converted into a second intermediate frequency signal equal to a difference between the frequencies.

The second local oscillating circuit 6b oscillates at a frequency higher than the first intermediate frequency signal, but the oscillating frequency of the second local oscillating circuit 6b varies so that the second intermediate frequency signal is converted into any channel in the television broadcasting band. The second intermediate frequency signal is transmitted to a CATV cable (not shown) through the output amplifying circuit 7.

In the television signal transmitter, the level of the television channel signal input to the first frequency converting circuit 3 needs to be a prescribed value so that distortion characteristics or a C/N ratio of the second intermediate frequency signal is well maintained. Accordingly, an AGC circuit 8, which detects the level of the television channel signal input to the first frequency converting circuit 3 to generate an AGC voltage and controls the level changing unit by the AGC voltage, is provided. The AGC circuit 8 includes a first level detecting unit 8a and a differential amplifying circuit 8b. The level detected by the first level detecting unit 8a varies according to the number of the input television channel signals (channel number). Accordingly, when the channel number increases, the level changing unit 2 is controlled by a large AGC voltage and thus the level of the second intermediate frequency signal of each channel is changed (reduced).

Consequently, in order to solve this problem, an input channel number discriminating unit 9 is provided to switch the AGC voltage according to the input channel number. That is, the input channel number discriminating unit 9 has a second level detecting unit 9a for detecting the level of the television channel signal at a previous stage of the level changing unit 2, and a determination unit 9b for determining the input channel number from the size of the detected level. The detected level can be determined because it is proportional to the input channel number. Also, a plurality of reference voltage sources 10 (E1, E2, E3, and E4) for inputting reference voltages to the differential amplifying circuit 8b of the AGC circuit 8, and a switching unit 11 for switching the reference voltage sources 10 to supply the reference voltages to the differential amplifying circuit 8b are provided. Further, the high reference voltage is supplied to the differential amplifying circuit 8b so that the AGC voltage is not excessively reduced although the input channel number increases. Thus, the level of the second intermediate frequency signal is uniform in every channel, regardless of the number of the input television channel signals.

FIG. 2 is a view illustrating a frequency relationship among the input television channel signal IF, the first intermediate frequency signal 1st/IF, the first local oscillating signal Lo1, the second intermediate frequency signal 2nd/IF, and the second local oscillating signal Lo2.

For example, as shown in FIG. 2, when the television channel signal IF of four channels is input, it is frequency-shifted to a higher frequency by the frequency of the first local oscillating signal to be converted into the first intermediate frequency signal 1st/IF, and the first intermediate frequency signal of the four channels passes through the band-pass filter 4. At this time, if a difference between a band edge frequency of the channel 1st/IF/Low having a lowest frequency of the first intermediate frequency signal and the frequency of the first local oscillating signal is too small, the first local oscillating signal is not completely removed by the band-pass filter 4 and is input to the second frequency converting circuit 6. Accordingly, an interference signal may be output by interference with the second local oscillating signal.

If the difference between the band edge frequency of the channel having the lowest frequency and the frequency of the first local oscillating signal becomes large in order to remove the first local oscillating signal by the band-pass filter 4, any problem does not occur. However, in this case, it is disadvantageous in that the oscillating frequency of the band-pass filter 4 and the oscillating frequency of the second local oscillating circuit 6b increase. Accordingly, when the band IF/Low of one channel is provided adjacent to the low frequency of the intermediate frequency band IF/Std (which varies according to country) of the television system and the channel band of the plural television signals is provided in the band higher than the above-mentioned band, the frequency of the band-pass filter 4 and the oscillating frequency of the second local oscillating circuit 6b does not increase and the first local oscillating signal can also be removed by the band-pass filter 4.

Furthermore, although the kind of the television signal is not specially limited in the description of the invention, a digital television signal as well as an analog television signal can be applied.

According to a first aspect of the invention, a television signal transmitter includes a first frequency converting circuit that converts a television channel signal lower than a television broadcasting band into a first intermediate frequency signal higher than the television broadcasting band and a second frequency converting circuit that converts the first intermediate frequency signal into the television broadcasting band and outputs it. In this case, a pass-band between an input port and an output port is a transmission band of a plurality of successive channels. Accordingly, it is possible to simultaneously transmit the television signals of the plurality of the channels.

Also, according to a second aspect of the invention, in the television signal transmitter, a level changing unit is provided at a previous stage of the first frequency converting circuit, and an AGC circuit that detects a level of the television channel signal input to the first frequency converting circuit to generate an AGC voltage and controls the level changing unit to make the level of the television channel signal input to the first frequency converting circuit uniform by use of the AGC voltage and an input channel number discriminating unit that detects the level of the television channel signal at the previous stage of the level changing unit to discriminate the channel number of the television channel signal input to an input amplifying circuit are provided, and the AGC voltage is converted according to the channel number. Therefore, it is possible to uniform the levels of the channel signals transmitted at the television broadcasting band regardless of the number of the input television channel signals.

Furthermore, according to a third aspect of the invention, in the television signal transmitter, the television channel signal is provided at a frequency band higher than the band of one channel adjacent to the lower frequency of the intermediate frequency band of a television system. Therefore, the first local oscillating signal can not pass through a band pass filter and thus an interference signal can be suppressed.

1. A television signal transmitter comprising:
a first frequency converting circuit that converts a television channel signal lower than a television broadcasting band into a first intermediate frequency signal higher than the television broadcasting band; and
a second frequency converting circuit that converts the first intermediate frequency signal into the television broadcasting band and outputs it,
wherein a pass-band between an input port and an output port is a transmission band of a plurality of successive channels.

2. The television signal transmitter according to claim 1,
wherein a level changing unit is provided at a previous stage of the first frequency converting circuit, an Automatic Gain Control (AGC) circuit that detects a level of the television channel signal input to the first frequency converting circuit to generate an AGC voltage and controls the level changing unit to make the level of the television channel signal input to the first frequency converting circuit uniform by use of the AGC voltage and an input channel number discriminating unit that detects the level of the television channel signal at the previous stage of the level changing unit to discriminate the channel number of the television channel signal input to an input amplifying circuit are provided, and the AGC voltage is converted according to the channel number.

3. The television signal transmitter according to claim 1,
wherein the television channel signal is provided at a frequency band higher than the band of one channel adjacent to the lower frequency of the intermediate frequency band of a television system.
